(19) United States
(12) Patent Application Publication
(10) Pub. No.: US 2003/0055846 A1
(43) Pub. Date: Mar. 20, 2003

(54) Method and system for providing field replaceable units in a personal computer

(75) Inventors: Richard Wayne Cheston, Morrisville, NC (US); Daryl Carvis Cromer, Apex, NC (US); Howard Jeffrey Locker, Cary, NC (US); David Rhoades, Apex, NC (US); James Peter Ward, Raleigh, NC (US)

Correspondence Address: BRACEWELL & PATTERSON, L.L.P., Intellectual Property Law, P.O. Box 969, Austin, TX, 78767-0969, US

(73) Assignee: International Business Machines Corporation, Armonk, NY

(21) Appl. No.: 09/957,572

(22) Filed: Sep. 20, 2001

(51) Int. Cl. G06F 12/00

(52) U.S. Cl. 707/203

(57) ABSTRACT

A method and system for providing field replaceable units (FRU's) to a personal computer being repaired of updated. A software agent, installed on the personal computer, collects identification information about all FRU's in the personal computer. The collected identification information is stored in a memory register in the personal computer on a scheduled periodic basis, and then transmitted to and stored on a remote service computer. A field service technician, upon receipt of a repair request for the personal computer, retrieves the identification information from the remote service computer identifying all FRU's for the uniquely identified personal computer. The technician then brings all FRU's used by the personal computer to the field repair site so that the needed FRU is readily available, thus avoiding multiple trips that would be required to first visually inspect the components of the personal computer and then return with the needed FRU's.

### BACKGROUND OF THE INVENTION

1. Technical Field

The present invention relates in general to the field of computers, and in particular, to the field repair of a personal computer. Still more particularly, the present invention relates to an improved method and system for delivering to the personal computer any Field Replaceable Units (FRU's) that may be replaced to repair the personal computer.

2. Description of the Related Art

The computer industry's transition to Configure To Order (CTO) computer sales, especially on sales through the Internet, has significantly increased the complexity of providing service and support. In non-CTO computer sales, a single machine type model number typically defined the Personal Computer (PC) and the majority of its components. In CTO computer sales, there may be numerous configurations of a PC, using components from several vendors, each offering different models and versions of the component. An additional complication is that many computer manufacturers will add/migrate components to the PC within an internal configuration, such as transferring communication adapters from old to new PC systems. To understand what is inside the machine requires coordinating databases at the various Original Equipment Manufacturer (OEM) PC suppliers, and then updating and tracking changes to the PC after it is deployed.

Another complication is that companies using PC's are rapidly outsourcing system maintenance. Repairs can be extremely difficult from a remote location, thus a repair technician must usually travel to the PC's physical site. The physical location of the customer's PC can range from within a building to remote public locations such as sales offices located around the country, lobbies and data entry centers. As a result, a computer maintenance company is forced to make a series of expensive field calls to correct the program with the PC. The service personnel must visit the site and determine the problem, return to a warehouse or shop to retrieve the needed Field Replaceable Units (FRU's), and then revisit the site to install the new parts. This is a lengthy process that may require days or weeks to resolve an issue. Downtime for a PC frequently means idle workers and loss of productivity or impact to the business. Multiple visits also add significant cost to the service organization. Waiting for days while the service personnel is making numerous service calls is unacceptable. The alternative of providing a set of FRU's to each maintenance person that includes all FRU's for all PC's is unacceptable due to the cost of inventory and the rate of change of technology.

A typical prior art method for replacing FRU's in the field is described in U.S. Pat. No. 5,287,505, issued to Calvert et al. on Feb. 15, 1994. The Calvert '505 invention utilizes a probability algorithm, either dynamic or preset by the manufacturer, to determine which FRU is most likely to fail. This system is appropriate for midrange and mainframe data-processing systems that have numerous redundant logic that helps determine which FRU's need replacement as it must typically be run on a separate sub-processor of the mainframe. Such a system is not appropriate for a smaller PC system having a single central processing unit (CPU) and only a handful of FRU's.

It should therefore be apparent that there exists a need for a method and system that can be used on a PC that determines and transmits to a remote location a list of all FRU's in a specific PC, such that a repair technician can bring to the field all FRU's that may be needed for that specific PC system. Further, it would be desirable to devise a system having the means to implement a method for providing replacement FRU components to the repair technician in the field. In addition, it would also be desirable to devise a computer program product for generating a listing of all FRU's that may be needed at the repair site in the field by the repair technician for a specifically identified PC system.

### SUMMARY OF THE INVENTION

The present invention is a method and system for providing field replaceable units (FRU's) to a personal computer being repaired of updated. A software agent, installed on the personal computer, collects identification information about all FRU's in the personal computer. The collected identification information is stored in a memory register in the personal computer on a scheduled periodic basis, and then transmitted to and stored on a remote service computer. A field service technician, upon receipt of a repair request for the personal computer, retrieves the identification information from the remote service computer identifying all FRU's for the uniquely identified personal computer. The technician then brings all FRU's used by the personal computer to the field repair site so that the FRU needed for replacement is readily available, thus avoiding multiple trips that would be required to first visually inspect and identify the components of the personal computer and then returning with the needed FRU's.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as the preferred mode of use, from the objects and advantages thereof, will best be understood by reference to the following detailed description of an illustrative embodiment when read in conjunction with the accompanying drawings, wherein:

FIG. 1 depicts a personal computer having field replaceable units (FRU's);

FIG. 2 illustrates in flowchart form steps used to identify FRU's in a personal computer using the present invention; and

FIGS. 3a and 3b depict a software diagram of the inventive FRU software agent polling FRU's in the personal computer.

### DETAILED DESCRIPTION OF THE PREFERRED EMBODIMENT

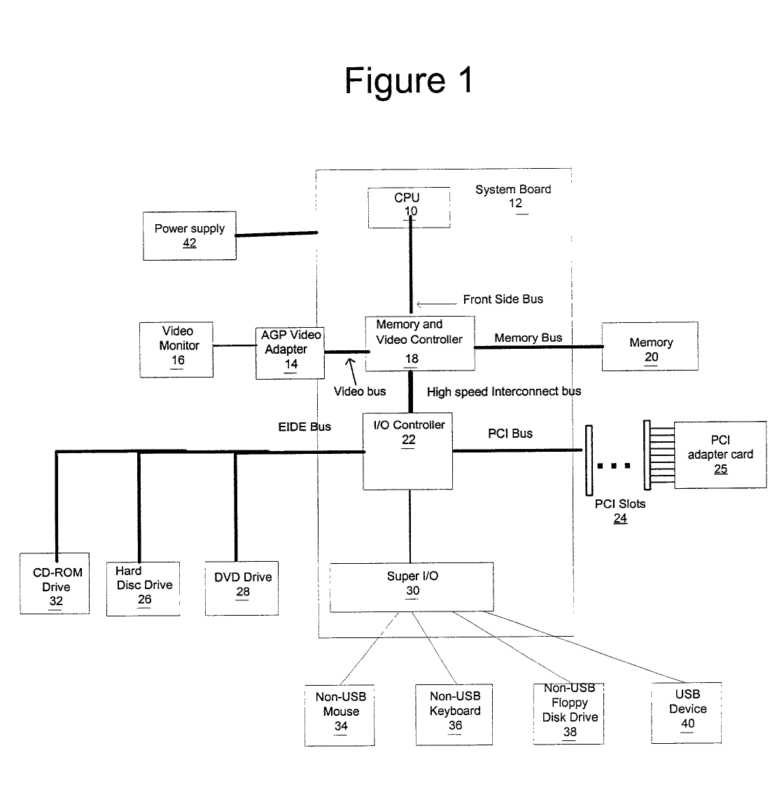

With reference now to the drawings and in particular to FIG. 1, there is depicted a high-level block diagram of a computer architecture utilizing Field Replaceable Unit (FRU) components. The FRU's depicted and/or described are representative of those known by those skilled in the art of computer architecture, and are not intended to be a complete representation of all FRU's of all FRU types and connections that may be used with the present invention.

In a preferred embodiment of a personal computer (PC) that may be used with the present invention, a system board 12 includes a Central Processing Unit (CPU) 10, a memory and video controller 18, an Input/Output (I/O) controller 22 and a Super I/O 30. CPU 10 is connected to memory and video controller 18 via a front side bus (also referred to in the art as a processor interface bus, host bus or system bus). Connected to memory and video controller 18 via a video bus is an advanced Graphic Peripheral (AGP) Video Adapter 14 that drives a video monitor 16. Memory and video controller 18 contains a chip or chipset arbiter logic circuit having a memory controller, a video controller, and a high-speed interconnect bus source. Memory and video controller 18 includes the necessary interface electronics to strengthen signals from CPU 10, and to separate signals going to and from memory 20 from those signals going to and from I/O devices described below. Memory 20 is preferably connected to memory and video controller 18 via a high-speed memory bus.

Memory and video controller 18 is connected via the high-speed interconnect bus to I/O controller 22, a chip or chipset I/O arbiter that includes the necessary interface logic to convey signals from the high-speed interconnect bus to (typically slower) I/O interfaces, including a Super I/O 30. Super I/O 30 is preferably a chip or chipset including necessary logic and interfacing for a non-Universal Serial Bus (USB) mouse 34, a non-USB keyboard 36, a non-USB floppy disk drive 38, and a USB device 40. USB device 40 may be any device connectable to a USB interface, including a magnetic mass storage device such as a floppy disc drive or hard drive, an optical mass storage device such as a CD-ROM, a mouse or a keyboard.

I/O controller 22 also contains the necessary logic and interfacing for an Enhanced Integrated Drive Electronics (EIDE) bus. Connected to the EIDE bus are EIDE protocol devices such as a hard disc drive 26, a Digital Video Disc (DVD) drive 28 and a Compact Disc-Read Only Memory (CD-ROM) drive 32.

The entire PC also has a power supply 42, shown as connected to system board 12 but understood to provide power to the entire PC. System board 12 also has multiple PCI slots 24 for various Peripheral Component Interconnect (PCI) adapter cards 25. PCI adapter cards 25 allow for flexible functions not included on system board 12. Examples of PCI adapter cards 25 include communication cards, Small Computer System Interface (SCSI) cards, Institute for Electrical and Electronic Engineers (IEEE) standard IEEE 1394 Firewire interfaces, and other I/O interfaces.

Of the above described components of a personal computer (PC) system, the following are typically easily replaced by a field technician with minimal tools and equipment, and are therefore referred to as Field Replaceable Units (FRU):

CPU 10

System Board 12

AGP Video Adapter 14

Video Monitor 16

Memory 20 (which may be more than one memory FRU)

Hard Disc Drive 26

DVD Drive 28

EIDE CD-ROM Drive 32

Non-USB Mouse 34

Non-USB Keyboard 36

Non-USB Floppy Disk Drive 38

USB Device 40

Power Supply 42

PCI Adapter cards 25.

Other PC components shown or not shown may also be considered FRU's, depending on their ease of replacement, preferably as a plug-in device without the need for field soldering.

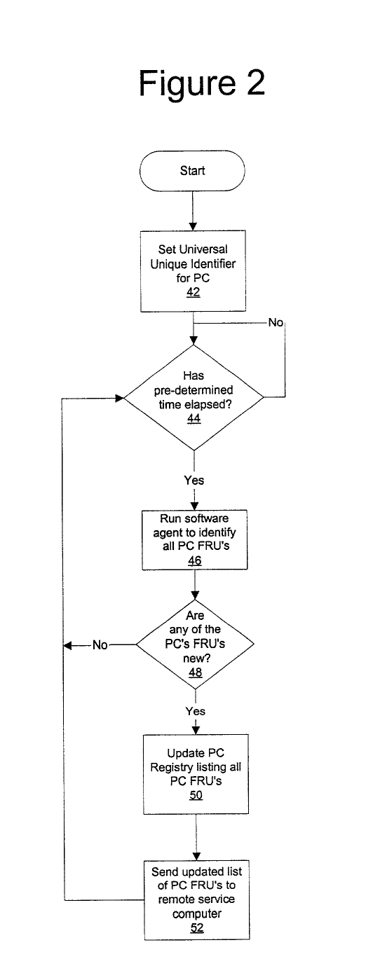

Referring now to FIG. 2, the PC having FRU's is assigned a Universal Unique IDentifier (UUID), as depicted in block 42. The UUID is typically set by the manufacturer of the PC. The UUID is unique because it contains both a time identifier and a machine identifier. The time identifier ensures that two UUID's produced on the same machine are unique because they are produced at different times. The machine identifier, on the other hand, ensures that two UUID's produced at the same time are unique because they were produced on different machines. The UUID associated with a particular personal computer identifies the computer system, but not the physical location of the personal computer.

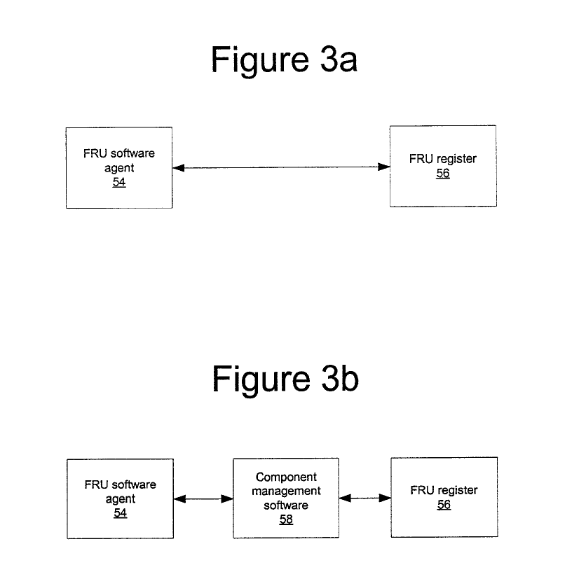

As depicted in block 44, an FRU software agent 54, described further below and depicted in FIGS. 3a and 3b, queries whether a predetermined time has elapsed. In the preferred embodiment, this predetermined time is set by the user of the invention, and may be either after a temporal unit of time (e.g., day, week, month) has elapsed, or after an event has occurred, such as a boot-up of the PC, power shutdown of the PC or installation of a new FRU. When such a pre-determined time has elapsed, FRU software agent 54 identifies all FRU's being used in the PC system in a manner described below.

In the preferred embodiment, identification of the FRU's requires reading and storing a register for each FRU. All FRU's have registers stored within their hardware to identify the FRU. This identification register preferably includes binary code (either numeric or American Standard Code for Information Interchange ASCII alphanumeric nomenclature) that identifies the unique class of the FRU (e.g., modem, video card, hard drive), the name of the manufacturer and the unique part number assigned by the manufacturer for the FRU.

Referencing now FIG. 3a, in a preferred embodiment FRU software agent 54 may obtain an FRU register 56 stored in a specific FRU by directly accessing the FRU and its FRU register 56 by using a bus protocol appropriate for that FRU. In another preferred embodiment, FRU register 56 may be obtained through a component management software 58, as illustrated in FIG. 3b.

When FRU software agent 54 directly obtains FRU register 56 as depicted in FIG. 3a, the appropriate bus protocol preferably is followed. That is, a Peripheral Component Interconnect (PCI) bus (not shown) uses a protocol for querying the FRU register 56 that is typically different from the protocol used by a Universal Serial Bus (USB) or Industry Standard Architecture (ISA) bus or an Integrated Drive Electronics (IDE) bus. FRU software agent 54 thus queries the FRU for its FRU register 56 using the appropriate bus protocol for the FRU according to its bus type.

In the alternative preferred embodiment depicted in FIG. 3b, FRU software agent 54 obtains the FRU register 56 for each FRU in the PC by querying a component management software 58. One such component management software 58 that may be used by the present invention, and described here for illustrative purposes, is a Desktop Management Interface (DMI) developed by the Distributed Management Task Force, Inc. In the DMI architecture, the format of all FRU registers 56 are standardized and stored in a designated memory location into a listing of FRU registers 56. This listing is then accessed and stored on the PC by the FRU software agent 54.

In either preferred embodiment described for identifying FRU's for the specific uniquely identified PC, FRU registers 56 are compared to a listing of FRU's for that PC, as illustrated in block 48. If any of the FRU's are new (as demonstrated by a new FRU register 56), the PC registry listing all PC FRU registers 56 is updated, as depicted in block 50, and the updated list of the PC's FRU's is transmitted to a remote service computer, as illustrated in block 52. The transmission may be via a telephone line or a network connection (not shown).

The remote service computer (not shown) is accessible by a service technician. When the service technician receives a service request for a computer, he/she accesses a memory location in the service computer listing all FRU's for the PC requiring service. Since the number of FRU's for any specific PC is limited, the service technician is able to take to the field repair site all FRU's for the specific PC that might be needed to repair the PC. Thus, the service technician has all FRU's on hand for the repair installation, and expensive time-consuming return trips with the needed FRU part are avoided.

While the invention has been particularly shown and described with reference to a preferred embodiment, it will be understood by those skilled in the art that various changes in form and detail may be made therein without departing from the spirit and scope of the invention.

What is claimed is:

1. A method for providing field replaceable units (FRU's) to a personal computer, said method comprising:
installing a software agent on a personal computer;
collecting identification information about all FRU's in the personal computer;
storing via the software agent the FRU identification information in a memory location in the personal computer on a scheduled periodic basis;
transmitting the FRU identification information to a remote service computer;
storing the FRU identification information for the personal computer on the remote service computer;
retrieving, in response to a repair request notification, the FRU identification for the personal computer from the remote service computer; and
transporting to the personal computer the FRU's identified for the personal computer.

2. The method of claim 1, wherein the step for collecting identification information about all FRU's in the personal computer is performed by querying a component management software installed on the personal computer.

3. The method of claim 1, further comprising identifying the personal computer with a Universal Unique Identifier.

4. The method of claim 1, wherein the steps of transmitting and storing the FRU identification information on the remote service computer are performed on the scheduled periodic basis.

5. A system for providing field replaceable units (FRU's) to a personal computer, said method comprising:
means for installing a software agent on a personal computer;
means for collecting identification information about all FRU's in the personal computer;
means for storing via the software agent the FRU identification information in a memory location in the personal computer on a scheduled periodic basis;
means for transmitting the FRU identification information to a remote service computer;
means for storing the FRU identification information for the personal computer on the remote service computer;
means for retrieving, in response to a repair request notification, the FRU identification for the personal computer from the remote service computer; and
means for transporting to the personal computer the FRU's identified for the personal computer.

6. The system of claim 5, wherein the step for collecting identification information about all FRU's in the personal computer is performed by querying a component management software installed on the personal computer.

7. The system of claim 5, further comprising means for identifying the personal computer with a Universal Unique Identifier.

8. The system of claim 5, wherein the steps of transmitting and storing the FRU identification information on the remote service computer are performed on the scheduled periodic basis.

9. A computer program product for providing field replaceable units (FRU's) to a personal computer, said computer program product comprising:
computer program code for installing a software agent on a personal computer;
computer program code for collecting identification information about all FRU's in the personal computer;
computer program code for storing via the software agent the FRU identification information in a memory location in the personal computer on a scheduled periodic basis;
computer program code for transmitting the FRU identification information to a remote service computer;
computer program code for storing the FRU identification information for the personal computer on the remote service computer;
computer program code for retrieving, in response to a repair request notification, the FRU identification for the personal computer from the remote service computer; and
computer program code for transporting to the personal computer the FRU's identified for the personal computer.

10. The computer program product of claim 9, wherein the step for collecting identification information about all FRU's in the personal computer is performed by querying a component management software installed on the personal computer.

11. The computer program product of claim 9, further comprising computer program code for identifying the personal computer with a Universal Unique Identifier.

12. The computer program product of claim 9, wherein the steps of transmitting and storing the FRU identification information on the remote service computer are performed on the scheduled periodic basis.
